(19) United States
(12) Patent Application Publication
(10) Pub. No.: US 2025/0319691 A1
(43) Pub. Date: Oct. 16, 2025

(54) FOOD PACKAGING MATERIAL AND METHOD FOR MANUFACTURING THE SAME

(71) Applicant: NAN YA PLASTICS CORPORATION, TAIPEI (TW)

(72) Inventors: CHING-YAO YUAN, TAIPEI (TW); HUNG-YI CHANG, TAIPEI (TW); TENG-KO MA, TAIPEI (TW); WEI-TANG LIAO, TAIPEI (TW)

(21) Appl. No.: 18/746,059

(22) Filed: Jun. 18, 2024

(30) Foreign Application Priority Data
Apr. 11, 2024 (TW) 113113454

(51) Int. Cl. B32B 27/08; B32B 7/027; B32B 27/20; B32B 27/32

(52) U.S. Cl. CPC B32B 27/08; B32B 7/027; B32B 27/20; B32B 27/32; B32B 2250/03; B32B 2250/242; B32B 2307/306; B32B 2307/7376; B32B 2439/70

(57) ABSTRACT

A food packaging material and a method for manufacturing the same are provided. The food packaging material includes a cast polypropylene layer, a heat resistant layer, and a middle layer. The middle layer is disposed between the cast polypropylene layer and the heat resistant layer. A material of the cast polypropylene layer includes a first propylene copolymer. A material of the heat resistant layer includes a propylene homopolymer, a petroleum resin, and an inorganic filler. A material of the middle layer includes a second propylene copolymer. A melting point of the heat resistant layer is higher than a melting point of the cast polypropylene layer. The melting point of the cast polypropylene layer is higher than a melting point of the middle layer.

### CROSS-REFERENCE TO RELATED PATENT APPLICATION

This application claims the benefit of priority to Taiwan Patent Application No. 113113454, filed on Apr. 11, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a food packaging material and a method for manufacturing the same, and more particularly to a food packaging material which is suitable for heat-sealing package or vacuum package and a method for manufacturing the same.

### BACKGROUND OF THE DISCLOSURE

Food packaging materials that are currently available on the market are generally formed from a composite material, such as food packaging materials that include a polyester layer, an aluminum foil layer, and a polypropylene layer. Due to differences in materials, the food packaging material formed from a composite material cannot be directly recycled, thereby producing a lot of disposable waste which raises environmental concerns.

In addition, an adhesive is usually used for lamination of different materials. The step of coating the adhesive tends to complicate a manufacturing process, and a solvent used in the adhesive also pollutes the environment. Therefore, from a long-term perspective, the food packaging material formed from the composite material is not eco-friendly.

On the other hand, the food packaging material formed from a single material can be directly recycled. However, physical properties of the food packaging material formed from a single material are usually weaker than those of the food packaging material formed from a composite material.

Therefore, how to manufacture a food packaging material formed from a single material under the condition of maintaining good physical properties by improving its material and structure has become an important issue to be addressed in the relevant industry.

### SUMMARY OF THE DISCLOSURE

In response to the above-referenced technical inadequacy, the present disclosure provides a food packaging material and a method for manufacturing the same.

In order to solve the above-mentioned problems, one of the technical aspects adopted by the present disclosure is to provide a food packaging material. The food packaging material includes a cast polypropylene layer, a heat resistant layer, and a middle layer. The middle layer is disposed between the cast polypropylene layer and the heat resistant layer. A material of the cast polypropylene layer includes a first propylene copolymer. A material of the heat resistant layer includes a propylene homopolymer, a petroleum resin, and an inorganic filler. A material of the middle layer includes a second propylene copolymer. A melting point of the heat resistant layer is higher than a melting point of the cast polypropylene layer. The melting point of the cast polypropylene layer is higher than a melting point of the middle layer.

In one of the possible or preferred embodiments, a melting point of the propylene homopolymer ranges from 160° C. to 170° C.

In one of the possible or preferred embodiments, a melting point of the first propylene copolymer ranges from 145° C. to 159° C.

In one of the possible or preferred embodiments, a melting point of the second propylene copolymer ranges from 125° C. to 140° C.

In one of the possible or preferred embodiments, based on a total weight of the propylene homopolymer, the petroleum resin, and the inorganic filler being 100 wt %, an amount of the propylene homopolymer ranges from 87 wt % to 94 wt %, and an amount of the petroleum resin ranges from 1.5 wt % to 5 wt %.

In one of the possible or preferred embodiments, based on a total weight of the first propylene copolymer being 100 wt %, the first propylene copolymer is polymerized from 90 wt % to 99.99 wt % of a propylene monomer and 0.01 wt % to 10 wt % of an ethylene monomer.

In one of the possible or preferred embodiments, based on a total weight of the second propylene copolymer being 100 wt %, the second propylene copolymer is polymerized from 70 wt % to 85 wt % of a propylene monomer and 15 wt % to 30 wt % of an ethylene monomer.

In one of the possible or preferred embodiments, the petroleum resin is a hydrogenated petroleum resin having 5 or 10 carbon atoms.

In one of the possible or preferred embodiments, the petroleum resin is an aromatic copolymer hydrogenated petroleum resin reacted from a hydrogenated petroleum resin having 5 or 10 carbon atoms and an aromatic compound.

In one of the possible or preferred embodiments, the hydrogenated petroleum resin having 5 or 10 carbon atoms is a piperylene hydrogenated resin or a dicyclopentadiene hydrogenated resin.

In one of the possible or preferred embodiments, the hydrogenated petroleum resin having 5 or 10 carbon atoms is a piperylene hydrogenated resin or a dicyclopentadiene hydrogenated resin.

In one of the possible or preferred embodiments, a thickness of the middle layer ranges from 18 μm to 20 μm, a thickness of the cast polypropylene layer ranges from 50 μm to 70 μm, and a thickness of the heat resistant layer ranges from 20 μm to 30 μm.

In order to solve the above-mentioned problems, another one of the technical aspects adopted by the present disclosure is to provide a method for manufacturing a food packaging material. The method includes steps of: implementing a casting process to form a cast polypropylene layer; implementing a biaxial extension process to form a laminate structure; and disposing the cast polypropylene layer onto the laminate structure so as to obtain a food packaging material. The cast polypropylene layer contacts the middle layer. A material of the cast polypropylene layer includes a first propylene copolymer. The laminate structure includes a middle layer and a heat resistant layer. A material of the middle layer includes a second propylene copolymer, and a material of the heat resistant layer includes a propylene homopolymer, a petroleum resin, and an inorganic filler. A melting point of the heat resistant layer is higher than a melting point of the cast polypropylene layer, and the melting point of the cast polypropylene layer is higher than a melting point of the middle layer.

Therefore, in the food packaging material provided by the present disclosure, by virtue of “a material of the heat resistant layer including a propylene homopolymer, a petroleum resin, and an inorganic filler” and “the melting point of the heat resistant layer being higher than the melting point of the cast polypropylene layer, and the melting point of the cast polypropylene layer being higher than the melting point of the middle layer,” the food packaging material can have the convenience of direct recyclability and good physical properties.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic side view of a food packaging material according to present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

In order to solve the problem that a conventional food packaging material cannot be directly recycled due to having a complex composite material, the present disclosure provides a food packaging material formed from a single material.

A main material of the food packaging material of the present disclosure is polypropylene. Despite being formed from a single material, the food packaging material can still have good physical properties, such as a high tensile strength, a low shrinkage, and a high heat resistance.

The food packaging material of the present disclosure is a multi-layered structure so as to achieve good physical properties. A design concept of the food packaging material is to dispose a layer that has a lower melting point between two layers that have higher melting points, such that the food packaging material can have flexibility and a high heat resistance.

In addition, the melting points of the two outer layers that have the higher melting points are different from each other, and a difference between the melting points can range from 5° C. to 25° C. As a result, the food packaging material can also be used as a heat-sealing material and undergo a heat-sealing process at an appropriate temperature range. Therefore, the food packaging material of the present disclosure can have a wide range of application in packaging and can be used to replace the conventional food packaging material.

In order to enable the layers to have different properties under the premise of the same material, the types and the contents of the monomers for forming the layers can be adjusted, or other components can be added. Accordingly, the layers can have different melting points to meet the property expectation.

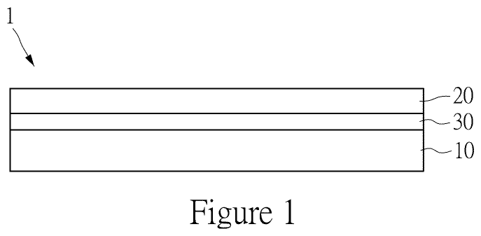

Referring to FIG. 1, the food packaging material 1 of the present disclosure is a three-layered structure. The food packaging material 1 includes a cast polypropylene layer 10, a heat resistant layer 20, and a middle layer 30. The middle layer 30 is disposed between the cast polypropylene layer 10 and the heat resistant layer 20.

In an exemplary embodiment, the cast polypropylene layer 10 is fixed on the middle layer 30 by an adhesive, and the heat resistant layer 20 and the middle layer 30 are integrally formed, but the present disclosure is not limited thereto. Specific manufacturing steps of the cast polypropylene layer 10, the heat resistant layer 20, and the middle layer 30 are described later.

The cast polypropylene layer 10 is used as an inner layer of the food packaging material 1 which may come in contact with food. In an exemplary embodiment, the cast polypropylene layer 10 is formed from a single material excluding other materials and additives. Under certain using conditions, the cast polypropylene layer 10 can also be used as a heat-sealing layer. In other words, a melting point of the cast polypropylene layer 10 is lower than a melting point of the heat resistant layer 20. When the cast polypropylene layer 10 is implemented by a heat-sealing process, the heat resistant layer 20 retains its original appearance and statement.

A material of the cast polypropylene layer 10 includes a first propylene copolymer. A melting point of the first propylene copolymer ranges from 145° C. to 159° C., preferably from 147° C. to 155° C. The melting point of the first propylene copolymer can be 148° C., 149° C., 150° C., 151° C., 152° C., 153° C., or 154° C. After experimental measurement, a melt flow index (MI) of the first propylene copolymer, measured under a temperature of 230° C. and a weight of 2.16 kg, ranges from 5 g/10 minutes to 10 g/10 minutes.

The cast polypropylene layer 10 is formed through a casting process. Since no extension step is evolved, the cast polypropylene layer 10 can have a high heat resistance and a high transparency.

The first propylene copolymer is copolymerized from a propylene monomer and an ethylene monomer. Based on a total weight of the first propylene copolymer being 100 wt %, the first propylene copolymer is copolymerized from 90 wt % to 99.99 wt % of the propylene monomer and 0.01 wt % to 10 wt % of the ethylene monomer. For example, an amount of the propylene monomer can be 92 wt %, 94 wt %, 96 wt %, or 98 wt %, and an amount of the ethylene monomer can be 1 wt %, 2 wt %, 4 wt %, 6 wt %, 8 wt %, or 9 wt %. During the polymerization, the ethylene monomer is randomly arranged between the propylene monomer, such that crystallinity and the melting point of the first propylene copolymer are decreased. By adding a small amount of the ethylene monomer, a toughness, an impact resistance, an oxidation resistance, and a long-term heat resistance of the first propylene copolymer can be improved.

The heat resistant layer 20 can be used as an outer layer of the food packaging material 1 which is exposed to external environment for long periods of time. The heat resistant layer 20 has the best heat resistance and the highest melting point in the food packaging material 1. Therefore, a process temperature during the heat-sealing process cannot be higher than the melting point of the heat resistant layer 20.

A material of the heat resistant layer 20 includes a propylene homopolymer, a petroleum resin, and an inorganic filler. A main component of the heat resistant layer 20 is the propylene homopolymer. That is, an amount of the propylene homopolymer is higher than 70 wt %.

Compared to a propylene copolymer, the molecular arrangement of the propylene homopolymer is more regular, such that the propylene homopolymer can have a higher melting point. Specifically, the melting point of the propylene homopolymer ranges from 160° C. to 170° C., and preferably from 165° C. to 168° C. For example, the melting point of the propylene homopolymer can be 166° C. or 167° C. After experimental measurement, a melt flow index of the propylene homopolymer, measured under a temperature of 230° C. and a weight of 2.16 kg, ranges from 2 g/10 minutes to 3 g/10 minutes.

The addition of the petroleum resin can enhance crystallinity of the amorphous phase of the propylene homopolymer, thereby increasing the melting point and rigidity of the propylene homopolymer. Preferably, the petroleum resin can be a hydrogenated petroleum resin. The addition of the hydrogenated petroleum resin enables the propylene homopolymer to have appropriate crystallinity. In addition, the hydrogenated petroleum resin can also act as a viscosity-increasing component and a reinforcing component to improve the mechanical properties and optical properties of the propylene homopolymer. Accordingly, the heat resistant layer 20 has good heat resistance.

For example, the petroleum resin can be a hydrogenated petroleum resin having 5 or 10 carbon atoms, such as a piperylene hydrogenated resin or a dicyclopentadiene (DCPD) hydrogenated resin. In an exemplary embodiment, the hydrogenated petroleum resin having 5 or 10 carbon atoms can also reacted with an aromatic compound so as to form an aromatic copolymer hydrogenated petroleum resin. Due to the addition of the aromatic copolymer hydrogenated petroleum resin, the heat resistant layer 20 can have the good heat resistance.

The addition of the inorganic filler can prevent the layers from sticking during the manufacturing process to avoid negatively affecting product quality. The inorganic filler can be silicon dioxide, such as silicon dioxide having a size ranging from 2 μm to 15 μm. In an exemplary embodiment, the inorganic fillers with two particle sizes may be mixed, such as silicon dioxide having a size ranging from 1 μm to 3 μm, and silicon dioxide having a size ranging from 3.1 μm to 5 μm.

In an exemplary embodiment, based on a total weight of the propylene homopolymer, the petroleum resin, and the inorganic filler being 100 wt %, an amount of the propylene homopolymer ranges from 87 wt % to 94 wt %, an amount of the petroleum resin ranges from 1.5 wt % to 5 wt %, and an amount of the inorganic filler ranges from 0.03 wt % to 0.15 wt %. For example, the amount of the propylene homopolymer can be 88 wt %, 89 wt %, 90 wt %, 91 wt %, 92 wt %, or 93 wt %.

The middle layer 30 is a bendable and soft layer in the food packaging material 1, which enables the food packaging material 1 to be convenient in use. The middle layer 30 is disposed between the cast polypropylene layer 10 and the heat resistant layer 20. The middle layer 30 is the layer having the lowest melting point of the food packaging material 1. In other words, the melting point of the heat resistant layer 20 is higher than a melting point of the cast polypropylene layer 10, and the melting point of the cast polypropylene layer 10 is higher than a melting point of the middle layer 30.

A material of the middle layer 30 includes a second propylene copolymer, and can further include inorganic filler. A main component of the middle layer 30 is the second propylene copolymer. That is, an amount of the second propylene copolymer is higher than 70 wt %.

The melting point of the second propylene copolymer ranges from 125° C. to 140° C., preferably from 130° C. to 133° C. The melting point of the second propylene copolymer can be 131° C. or 132° C. After experimental measurement, a melt flow index (MI) of the second propylene copolymer, measured under a temperature of 230° C. and a weight of 2.16 kg, ranges from 5 g/10 minutes to 7 g/10 minutes.

The second propylene copolymer is copolymerized from a propylene monomer and an ethylene monomer. Based on a total weight of the second propylene copolymer being 100 wt %, the second propylene copolymer is copolymerized from 70 wt % to 85 wt % of the propylene monomer and 15 wt % to 30 wt % of the ethylene monomer. For example, an amount of the propylene monomer can be 72 wt %, 74 wt %, 76 wt %, 78 wt %, 80 wt %, 82 wt %, or 84 wt %, and an amount of the ethylene monomer can be 16 wt %, 18 wt %, 20 wt %, 22 wt %, 24 wt %, 26 wt %, or 28 wt %.

In short, by adjusting the types and structures of microscopic molecules, a propylene material can have different melting points, thereby allowing the properties of the layer to be controlled. The melting point of the propylene homopolymer is higher than the melting point of the first propylene copolymer, and the melting point of the first propylene copolymer is higher than the melting point of the propylene homopolymer. Therefore, a melting point of the heat resistant layer 20 is higher than the melting point of the cast polypropylene layer 10, and the melting point of the cast polypropylene layer 10 is higher than the melting point of the middle layer 30.

In order to enhance the convenience in use and the packaging functionality, a thickness of the cast polypropylene layer 10 can be adjusted to be higher than a thickness of the heat resistant layer 20, and the thickness of the heat resistant layer 20 can be adjusted to be higher than a thickness of the middle layer 30. In an exemplary embodiment, the thickness of the middle layer 30 ranges from 18 μm to 20 μm, the thickness of the cast polypropylene layer 10 ranges from 50 μm to 70 μm, and the thickness of the heat resistant layer 20 ranges from 20 μm to 30 μm.

The method for manufacturing the food packaging material of the present disclosure includes the following steps. The first polypropylene copolymer is used for a casting process to obtain the cast polypropylene layer (CPP film). In the casting process, the first polypropylene copolymer is melted by an extruder and then extruded through a T-shaped die. The first propylene copolymer under a molten state forms a sheet structure on a smoothly rotating roller barrel. After being cooled and shaped, the cast polypropylene layer can be obtained.

The propylene homopolymer, the petroleum resin, and the inorganic filler are mixed to form a heat resistant layer material. The second propylene copolymer and the inorganic filler are mixed to form a middle layer material. The heat resistant layer material and the middle layer material are respectively injected into inputs of a biaxial stretching machine. After being melted, extruded, and extended, a laminate structure can be obtained. The laminate structure includes the heat resistant layer and the middle layer which are integrally formed with each other. In other words, the heat resistant layer and the middle layer are biaxially oriented polypropylene films (BOPP film). As far as the product is concerned, no obvious interface can be observed between the heat resistant layer and the middle layer, despite a difference in composition between the heat resistant layer and the middle layer indeed existing.

The cast polypropylene layer is disposed onto the laminate structure, and the cast polypropylene layer contacts the middle layer, such that the food packaging material of the present disclosure can be obtained. Since the cast polypropylene layer and the laminate structure are already formed, the cast polypropylene layer is fixed on the laminate structure by a polyolefin adhesive, but the present is not limited thereto.

In an exemplary embodiment, the polyolefin adhesive is prepared by a polyolefin particle, a modifier, a hardener, and a mixed solvent. The polyolefin particle can be a propylene random copolymer. The modifier can be selected from the group consisting of: maleic anhydride, methyl tetrahydrophthalic anhydride (MTHPA), 3,4,5,6-tetrahydrophthalic anhydride, 1,2,3,6-tetrahydrophthalic anhydride (THPA), methylhexahydrophthalic anhydride (MHHPA), methyl nadic anhydride (MNA), and 2,3-naphthalenedicarboxylic anhydride. The hardener can be a polyisocyanate type hardener, such as DesmodurR ultra N3300, Desmodur® ultra N3600, or a combination thereof. The mixed solvent can include a non-polar solvent and a polar solvent. A weight of the non-polar solvent to the polar solvent ranges from 4:1 to 3:2. The non-polar solvent can be methylcyclohexane, cyclohexane, n-hexane, or a combination thereof. The polar solvent can be methyl ethyl ketone, ethyl acetate, methyl isobutyl ketone, n-propyl acetate, or a combination thereof. Preferably, the non-polar solvent is methylcyclohexane, and the polar solvent is methyl ethyl ketone, ethyl acetate, or a combination thereof.

It should be noted that an order of forming the cast polypropylene layer and the laminate structure is not limited to the above. The formation of the laminate structure can also be earlier than the formation of the cast polypropylene layer.

In order to measure properties of the food packaging material of the present disclosure, the food packaging material in Example 1 and Comparative Examples 1 and 2 are manufactured according to the steps mentioned above. Specific contents of layers are listed in Table 1. The difference between the food packaging material in Example and Comparative Examples resides in the content of the heat resistant layer. Specifically, a rigidity masterbatch is absent from Comparative Example 1. The rigidity masterbatch is absent from Comparative Example 2 and the propylene homopolymer is replaced by the second propylene copolymer.

For supplementary description, in order to enhance the uniformity of materials, the petroleum resin (the rigidity masterbatch) and the inorganic filler (anti-sticking agent masterbatch) can be added in forms of masterbatches. Specifically, an amount of the petroleum resin (the hydrogenated petroleum resin formed by the copolymerization of dicyclopentadiene and the aromatic compound) in the rigidity masterbatch ranges from 30 wt % to 50 wt %. An amount of the inorganic filler in the anti-sticking agent masterbatch ranges from 3 wt % to 5 wt %. In Table 1, according to the addition amount of the rigidity masterbatch and the anti-sticking agent masterbatch, the amounts of the petroleum resin and the inorganic filler can be calculated.

In order to prove that the food packaging material of the present disclosure has excellent properties, a tensile strength of the food packaging material is measured according to the ASTM D-638 standard. Shrinkage of the food packaging material relative to original size is measured after being placed at 120° C. or 150° C. for 3 minutes. A heat sealing strength is measured by heat sealing two pieces of the food packaging materials at a temperature of 180° C. and a pressure of 0.2 MPa for 1 second, and then tearing them off by a tensile testing machine at a speed of 300 m/min. In addition, a sticking temperature at which the food packaging materials are stuck with each other is also recorded so as to evaluate the heat resistance. The results are listed in Table 1.

TABLE 1

| | | Comparative | Comparative |
|---|---|---|---|
| | Example 1 | Example 1 | Example 2 |
| Heat resistant | 90% propylene | 98% propylene | 98% second |
| layer material | homopolymer | homopolymer | propylene |
| | 2% anti-sticking | 2% anti-sticking | copolymer |
| | agent masterbatch | agent masterbatch | 2% anti-sticking |
| | 8% rigidity | | agent masterbatch |
| | masterbatch | | |
| Middle layer | 98% second | 98% second | 98% second |
| material | propylene | propylene | propylene |
| | copolymer | copolymer | copolymer |
| | 2% anti-sticking | 2% anti-sticking | 2% anti-sticking |
| | agent masterbatch | agent masterbatch | agent masterbatch |

| Cast | 100% first | 100% first | 100% first |
|---|---|---|---|
| polypropylene | propylene | propylene | propylene |
| layer material | copolymer | copolymer | copolymer |
| Tensile | 36 to 39 | 23 to 26 | 20 to 23 |
| strength | | | |
| (MPa) | | | |
| Shrinkage at | 0 | 0 | 4 to 9 |
| 120° C. (%) | | | |
| Shrinkage at | 3 to 5 | 3 to 5 | 20 to 30 |
| 150° C. (%) | | | |
| Sticking | 175 | 175 | 158 |
| temperature | | | |
| (° C.) | | | |

According to the results of Table 1, the food packaging material of the present disclosure can have better tensile strength, thereby being capable of replacing the conventional food packaging material. Moreover, the food packaging material of the present disclosure has the advantage of being able to be directly recycled. In addition, the food packaging material of the present disclosure has a low shrinkage and a high heat resistance (higher sticking temperature). The size of the food packaging material can be maintained at 120° C., and only shrinks slightly at 150° C. Due to the outstanding properties mentioned above, the food packaging material of the present disclosure can be widely used in various applications, especially for heat sealing packaging and vacuum packaging.

### Beneficial Effects of the Embodiment

In conclusion, in the food packaging material provided by the present disclosure, by virtue of “a material of the heat resistant layer including a propylene homopolymer, a petroleum resin, and an inorganic filler” and “the melting point of the heat resistant layer being higher than the melting point of the cast polypropylene layer, and the melting point of the cast polypropylene layer being higher than the melting point of the middle layer,” the food packaging material can have the convenience of direct recyclability and good physical properties.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A food packaging material, comprising:
a cast polypropylene layer, wherein a material of the cast polypropylene layer includes a first propylene copolymer,
a heat resistant layer, wherein a material of the heat resistant layer includes a propylene homopolymer, a petroleum resin, and an inorganic filler; and
a middle layer disposed between the cast polypropylene layer and the heat resistant layer, wherein a material of the middle layer includes a second propylene copolymer;
wherein a melting point of the heat resistant layer is higher than a melting point of the cast polypropylene layer, and the melting point of the cast polypropylene layer is higher than a melting point of the middle layer.

2. The food packaging material according to claim 1, wherein a melting point of the propylene homopolymer ranges from 160° C. to 170° C.

3. The food packaging material according to claim 1, wherein a melting point of the first propylene copolymer ranges from 145° C. to 159° C.

4. The food packaging material according to claim 1, wherein a melting point of the second propylene copolymer ranges from 125° C. to 140° C.

5. The food packaging material according to claim 1, wherein, based on a total weight of the propylene homopolymer, the petroleum resin, and the inorganic filler being 100 wt %, an amount of the propylene homopolymer ranges from 87 wt % to 94 wt %, and an amount of the petroleum resin ranges from 1.5 wt % to 5 wt %.

6. The food packaging material according to claim 1, wherein, based on a total weight of the first propylene copolymer being 100 wt %, the first propylene copolymer is polymerized from 90 wt % to 99.99 wt % of a propylene monomer and 0.01 wt % to 10 wt % of an ethylene monomer.

7. The food packaging material according to claim 1, wherein, based on a total weight of the second propylene copolymer being 100 wt %, the second propylene copolymer is polymerized from 70 wt % to 85 wt % of a propylene monomer and 15 wt % to 30 wt % of an ethylene monomer.

8. The food packaging material according to claim 1, wherein the petroleum resin is a hydrogenated petroleum resin having 5 or 10 carbon atoms.

9. The food packaging material according to claim 1, wherein the petroleum resin is an aromatic copolymer hydrogenated petroleum resin reacted from a hydrogenated petroleum resin having 5 or 10 carbon atoms and an aromatic compound.

10. The food packaging material according to claim 8, wherein the hydrogenated petroleum resin having 5 or 10 carbon atoms is a piperylene hydrogenated resin or a dicyclopentadiene hydrogenated resin.

11. The food packaging material according to claim 9, wherein the hydrogenated petroleum resin having 5 or 10 carbon atoms is a piperylene hydrogenated resin or a dicyclopentadiene hydrogenated resin.

12. The food packaging material according to claim 1, wherein a thickness of the middle layer ranges from 18 μm to 20 μm, a thickness of the cast polypropylene layer ranges from 50 μm to 70 μm, and a thickness of the heat resistant layer ranges from 20 μm to 30 μm.

13. A method for manufacturing a food packaging material, comprising:
implementing a casting process to form a cast polypropylene layer, wherein a material of the cast polypropylene layer includes a first propylene copolymer,
implementing a biaxial extension process to form a laminate structure, the laminate structure including a middle layer and a heat resistant layer; wherein a material of the middle layer includes a second propylene copolymer, and a material of the heat resistant layer includes a propylene homopolymer, a petroleum resin, and an inorganic filler; and
disposing the cast polypropylene layer onto the laminate structure so as to obtain a food packaging material, wherein the cast polypropylene layer contacts the middle layer;
wherein a melting point of the heat resistant layer is higher than a melting point of the cast polypropylene layer, and the melting point of the cast polypropylene layer is higher than a melting point of the middle layer.
